(19) United States
(12) Patent Application Publication
(10) Pub. No.: US 2010/0090864 A1
(43) Pub. Date: Apr. 15, 2010

(54) Signaling Device

(76) Inventor: John C. Craig, Englewood, CO (US)

Correspondence Address: ADVANTIA LAW GROUP, 9035 SOUTH 1300 EAST, SUITE 200, SANDY, UT, 84094, US

(21) Appl. No.: 12/249,253

(22) Filed: Oct. 10, 2008

(51) Int. Cl. G08G 1/095; G08B 5/22

(52) U.S. Cl. 340/908; 340/815.45; 340/944

(57) ABSTRACT

A signaling device, configured to selectably display visual information, comprising an elongated light group configured to selectably project light from portions of the group. The device also comprises a multi-axis accelerometer configured to provide multi-axis device acceleration data. The signaling device further comprises a control module, in communication with the multi-axis accelerometer and the elongated light group and configured to process multi-axis acceleration data and configured to generate light illumination data and provide it to the elongated light group. The control module further comprises a program module configured to provide selectably programmable light illumination data; in addition to a wireless communication module. The device still further comprises a trigger module, a protective housing having a handle; a selectably removable storage module, in communication with the control module, configured to store light illumination pattern data; and a power module having a power amplifier configured to charge pump the power module.

### BACKGROUND OF THE INVENTION

### CROSS-REFERENCE TO RELATED APPLICATIONS

1. Field of the Invention

The present invention relates to signaling device, specifically a signaling device, configured to selectably display visual information.

2. Description of the Related Art

Signaling devices have been used to signal and guide vehicles and pedestrians in a specific manner for decades. The traffic light is a signaling device positioned at a road intersection, pedestrian crossing, or other location. Its purpose is to indicate, using a series of colors (Red-Yellow-Green), the correct moment to stop, drive, ride or walk, using a universal color code.

Traffic lights for vehicles usually contain three lamps: red, yellow, and green. Traffic lights for pedestrians normally have two main lights: a red light that means ‘stop’ and a green light that means ‘go’. There is usually a flashing phase (red in the US, green in Europe) that means ‘complete your crossing’. In most locales in North America, the colors used are a red for “stop/wait” and a bluish-white for “go.” While the “walk” signal is generally a walking human figure, North American pedestrian signals usually show an upraised hand for “stop,” while most other countries display a standing human figure. Some older American signals display the verbal commands “Walk” and “Don't Walk” or “Wait”.

There are also other types of signaling devices, such as, but not limited to: parking lot attendants indicating parking availability; airport attendants directing a plane to, and from, the runway; construction workers directing traffic; in addition to various embodiments of a signaling device, such as, but not limited to: emergency signaling, traffic signaling; distress signaling, and normal communication. Furthermore, the signaling device may only include lights, wherein a user directs the recipient in a particular direction with the lights. The signaling device may include a message or distress signal, wherein the user is trying to communicate a message or signal. The communication may also be a wireless communication.

However, with expanding technology signaling devices have not been limited to colors to indicate a signal. Complete messages or images are used to signal or guide vehicles or pedestrians along a directed route. Some improvements have been made in the field. Examples of references related to the present invention are described below, and the supported teachings of each reference are incorporated by reference herein:

U.S. Pat. No. 5,748,157, issued to Eason, discloses a display device is constructed with a support for cyclic or repetitive motion. An array of lights is mounted on the support for sweeping across a region of space during motion of the support. A microcontroller or other microprocessor is coupled to the lights for turning on and off the respective lights of the array. A periodically actuated switch such as an inertial switch is coupled to the microcontroller for measuring the time period or cycle time of a cycle of the cyclic or repetitive motion of the support and for indicating initiation of a cycle. The microcontroller is programmed for synchronizing the turning on and off of respective lights of the array according to the time period or cycle time of a cycle of the cyclic or repetitive motion of the support for forming at least one image across the region of space swept by the array of lights using persistence of vision of a viewer. According to one example the support is a hand held wand for hand held swinging motion back and forth. The array of lights is a column of LED's mounted along the wand for sweeping across a two dimensional area of space. The swinging motion of the wand back and forth can form e.g. alphanumeric characters, words, and sentences for conveying messages. Animated images may also be displayed. Other display devices in other environments with periodic, cyclic, or repetitive motion are also described.

U.S. Pat. No. 5,444,456, issued to Ohta et al., discloses in connection with a display apparatus that is held and swung by an operator to display images of pictures, letters, etc. in space using an afterimage effect, a party situated opposite to the operator is enabled to recognize the images displayed always at the central position of the swing range and with the same dimensions irrespective of the swinging speed and to see the same images displayed even of an asymmetrical pattern irrespective of the directions of the swing of the apparatus. The display apparatus has a transparent protective case covering both side faces, right and left, of an array of LEDs, a measuring unit to measure the cycle time of right and left reciprocating motion, a computing unit to process by computation the measured cycle time, a memory unit to memorize the processed results and a timer circuit unit to control turning the LEDs on and off. This set-up enables a party situated opposite to the operator of the display apparatus to see correct images of letters and pictures displayed always at the center of the swinging width range regardless of the swinging speed.

U.S. Pat. No. 6,626,728, issued to Holt, discloses a toy wand that is activated and controlled by a sequence of motions of the wand while in the hand of an operator. When moved through a specific sequence of motions (herein termed a “spell”, the wand will produce an appealing display of lights whose purpose is to amuse or entertain the wand operator or others in the viewing area. The toy wand comprises a casing, a means for detecting a sequence of motions, one or more lights, and a means for providing time-varying illumination from the lights as a function of the history of motions of the wand.

U.S. Pat. No. 6,150,947, issued to Shima, discloses a programmable sound effects device which utilizes a motion-sensitive mechanism for selecting unique sound effects. The device is comprised of an electronic motion-sensitive actuator, a sound effect storage media for storing a plurality of predetermined sound effects, and a playback mechanism for audibly emitting the motion-activated sound effects. This device is designed to be used with amusement and entertainment type products such as toys, games, dolls, and props, with exemplary uses in toy swords, drumsticks, magic wands, and the like. A preferred embodiment is comprised of a unit which is physically incorporated into the handle of a toy sword. As the user moves the toy sword in a predefined manner, the motion-sensitive actuator senses the motion and plays out a plurality of unique sound effects as a function of the user's movements. The motion-detection algorithm which triggers the different sound effects is programmable. In another embodiment, the device is contained within a single housing unit that is worn on the user's body. This embodiment is well suited for many toys, props, games, and the like that do not have any sound effects capability but would benefit from such capability.

U.S. Pat. No. 5,548,300, issued to Tokimoto, discloses a manually operated rotary type display device comprises a device body of an elongated bar-shaped configuration having a plurality of light emitting cells provided on the surface of the device body and arranged in alignment along a longitudinal direction thereof to form a light emitting cell array, an operation fulcrum member mounted on one end of the device body and rotatable about an axis perpendicular to the longitudinal direction of the device body, a rotary marker secured to the operation fulcrum member for co-rotation therewith and having at least one mark, rotation detecting means for obtaining a relative angular position information between the device body and the operation fulcrum member and rotation speed information by detecting the mark of the rotary marker, storage means for storing an image data to be displayed by rotational scanning of the light emitting cell array, and display control means for reading out the image data sequentially from the storage means in synchronism with a detection signal by the rotation detecting means.

U.S. Pat. No. 5,406,300, issued to Tokimoto et al., discloses a swing type aerial display system is adapted to aerially display a desired visual image utilizing a residual image effect of a moving light emitting array. In order to establish synchronization of the motion of said moving light emitting array and illuminating timing of individual cells in the light emitting array, the motion behavior of the system is monitored and timing to drive each individual cell is controlled in relation to the monitored motion behavior of the light emitting array, so that the desired image becomes visible at a desired position and desired configuration.

The inventions heretofore known suffer from a number of disadvantages which include being limited in application, being limited in functionality, being cumbersome, being difficult to use, being bulky, being expensive, being limited in versatility, being limited in adaptability, and being non-durable.

What is needed is a signaling device that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available signaling devices. Accordingly, the present invention has been developed to provide an adaptable and efficient signaling device.

In one embodiment, there is a signaling device, configured to selectably display visual information, wherein the signaling device may include an elongated light group configured to selectably project light from portions of the group. The elongated light group may further include a plurality of point lights. The signaling device may also include a multi-axis accelerometer configured to provide multi-axis device acceleration data. The signaling device may still further include a control module, in communication with the multi-axis accelerometer and the elongated light group and configured to process multi-axis acceleration data and configured to generate light illumination data and provide it to the elongated light group. The control module may further include a program module configured to provide selectably programmable light illumination data. The control module may still further include a wireless communication module, and a trigger module, in communication with the control module configured to toggle the light illumination data.

The signaling device may further include a protective housing having a handle. The signaling device may also include a selectably removable storage module, in communication with the control module, configured to store light illumination pattern data. The device may include a power module having a power amplifier configured to charge pump the power module; and a communication module in communication with the control module configured to provide remote communication with the device.

Reference throughout this specification to features, advantages, or similar language, does not imply that all of the features, and advantages, that may be realized with the present invention should be, or are, in any single embodiment of the invention. Rather, language referring to the features, and advantages, is understood to mean that a specific feature, advantage, or characteristic described in connection with an embodiment, is included in at least one embodiment of the present invention. Thus, discussion of the features, and advantages, and similar language, throughout this specification may, but do not necessarily, refer to the same embodiment.

Furthermore, the described features, advantages, and characteristics of the invention, may be combined in any suitable manner in one or more embodiments. One skilled in the relevant art will recognize that the invention can be practiced without one or more of the specific features, or advantages, of a particular embodiment. In other instances, additional features and advantages may be recognized in certain embodiments that may not be present in all embodiments of the invention.

These features, and advantages, of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. It is noted that the drawings of the invention are not to scale. The drawings are mere schematics representations, not intended to portray specific parameters of the invention. Understanding that these drawings depict only typical embodiments of the invention and are not, therefore, to be considered to be limiting in its scope, the invention will be described and explained with additional specificity and detail through the use of the accompanying drawings, in which:

FIG. 1 is a perspective view of a horizontally moving signaling device, according to one embodiment of the invention;

FIG. 2 is a perspective view of a vertically moving signaling device, according to one embodiment of the invention;

FIG. 3 is a block diagram of a signaling device, according to one embodiment of the invention;

FIG. 4 illustrates how FIGS. 5-8 are intended to be viewed;

FIGS. 5-8 together illustrate a circuit diagram of a signaling device, according to one embodiment of the invention; and

FIG. 9 is a flow chart diagram of a method of gathering and analyzing acceleration data of a signaling device, according to one embodiment of the invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will, nevertheless, be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Many of the functional units described in this specification have been labeled as modules, in order to more particularly emphasize their implementation independence. For example, a module may be implemented as a hardware circuit comprising custom VLSI circuits, or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of programmable, or executable code, may comprise one or more physical or logical blocks of computer instructions which may, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. As those skilled in the art will appreciate, any computers discussed herein may include an operating system (e.g., Windows Vista, NT, 95/98/2000, OS2; UNIX; Linux; Solaris; MacOS; and etc.) as well as various conventional support software and drivers typically associated with computers. The computers may be in a home or business environment with access to a network. In an exemplary embodiment, access is through the Internet through a commercially-available web-browser software package. Furthermore, the Internet communication may use protocols that skip a browser; in addition to lower level communications protocols.

The present invention may be described herein in terms of functional block components, screen shots, user interaction, optional selections, various processing steps, and the like. Each of such described herein may be one or more modules in exemplary embodiments of the invention. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, AJAX, extensible markup language (XML), with the various algorithms being implemented with any combination of data structures, objects, processes, routines, or other programming elements. Further, it should be noted that the present invention may employ any number of conventional techniques for data transmission, signaling, data processing, network control, and the like. Still further, the invention may detect or prevent security issues with a client-side scripting language, such as, JavaScript, VBScript or the like.

Additionally, many of the functional units and/or modules herein are described as being “in communication” with other functional units and/or modules. Being “in communication” refers to any manner and/or way in which functional units and/or modules, such as, but not limited to, computers, laptop computers, PDAs, modules, and other types of hardware and/or software, may be in communication with each other. Some non-limiting examples include communicating, sending, and/or receiving data and metadata via: a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties, in accordance with the present invention may be accomplished through any suitable communication channels, for non-limiting examples, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like.

Moreover, although the invention may be implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like, described herein are considered to be able to be combined in whole, or in part, one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

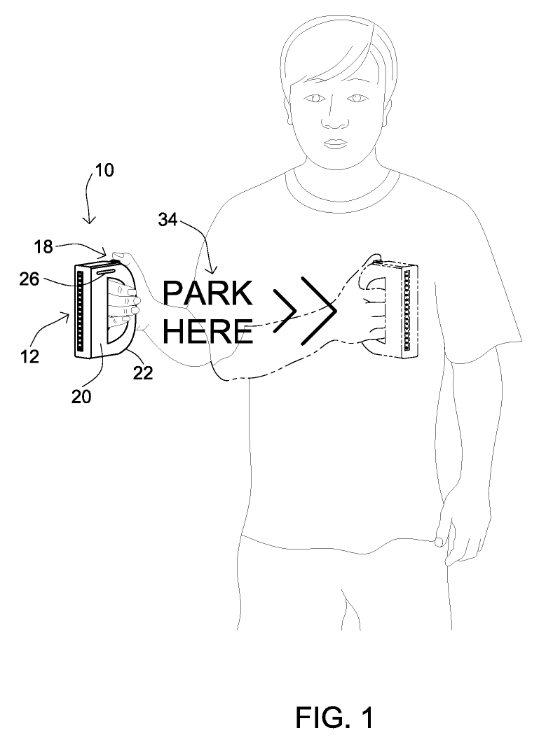

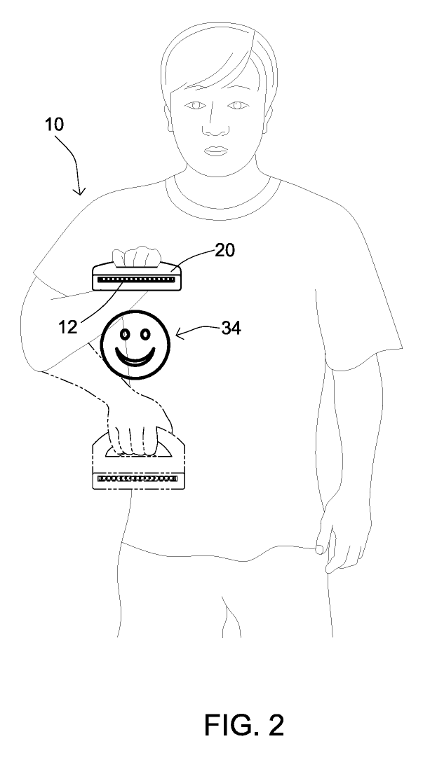

FIGS. 1 and 2 illustrate a signaling device 10, configured to selectably display visual information, comprising an elongated light group 12 configured to selectably project light from portions of the group. The elongated light group 12 further comprises a plurality of point lights, wherein the lights display visual information. As illustrated in FIG. 1, the signaling device 10 comprises a trigger module 18, configured to toggle the light illumination data. Also illustrated in FIG. 1, the signaling device 10 includes a protective housing 20 having a handle 22. The signaling device 10 further comprises a selectably removable storage module 26, configured to store light illumination pattern data.

In operation of one embodiment of the signaling device 10, a user holds the device 10, wherein the elongated light group 12 is directed away from the user. The user then begins to displace the device 10 in a side to side motion, wherein the elongated light group 12 is substantially directed away from the user. The user then engages the trigger module 18, wherein holding the trigger module 18 displays the image about the center of the side to side motion. The user may toggle through the images stored on the device 10 by pressing the trigger module 18. The elongated light group 12 is configured to indicate a plurality of images, wherein each individual light corresponds to a different image. As illustrated in FIG. 1, the user is displacing the device 10 in a side to side, horizontal motion. As illustrated in FIG. 2, the user is displacing the device 10 in an up and down, vertical motion.

In operation of another embodiment of the invention, wherein the user turns on, and holds, the device 10, wherein the elongated light group 12 is directed away from the user. The user then begins to displace the device 10 in a side to side motion, wherein the elongated light group 12 is substantially directed away from the user. The image will be displayed about the center of the movement. The user may then engage the trigger module 18, wherein pressing the trigger module 18 may toggle through the images stored on the device 10 by pressing the trigger module 18. The elongated light group 12 is configured to indicate a plurality of images, wherein each individual light corresponds to a different image. The device 10 may also include a sleep mode, wherein when the user stops displacing the device for a few seconds and the device 10 is on standby or is shut off.

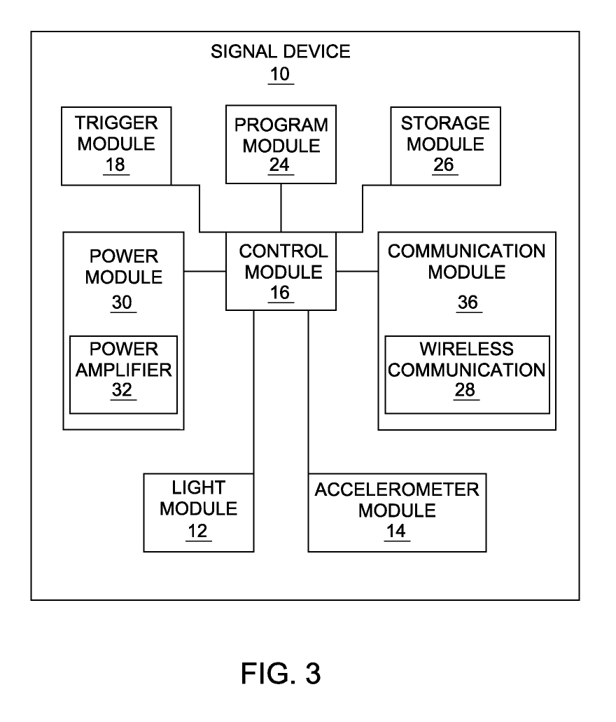

FIG. 3 illustrates a block diagram of a signaling device 10, according to one embodiment of the invention, wherein the device 10 includes a multi-axis accelerometer 14 configured to provide multi-axis device acceleration data. Non-limiting examples of multi-axis accelerometers include a Triple Axis Accelerometer Breakout-MMA7260Q, manufactured by Freescale Semiconductor, Inc. at 6501 William Cannon Drive West, Austin, Tex., 78735, USA, As illustrated in FIG. 3, the device 10 further includes a control module 16, in communication with the multi-axis accelerometer 14 and the elongated light group 12 and configured to process multi-axis acceleration data and configured to generate light illumination data and provide it to the elongated light group 12. The control module 16 further comprises a program module 24 configured to provide selectably programmable light illumination data.

In addition, the illustrated control module 16 further comprises a communication module 36, in communication with the control module 16, configured to provide remote communication with the device 10. The communication module 36 includes a wireless communication module 28, configured to send and/or receive light illumination data. The device 10 further includes a trigger module 18, in communication with the control module 16 configured to toggle the light illumination data. The device 10 also includes a selectably removable storage module 26, such as, but not limited to, a SanDisk Secure Digital Card, manufactured by SanDisk Corporation, at 601 McCarthy Boulevard, Milpitas, Calif., 95035, USA. The selectably removable storage module 26 is in communication with the control module 16, configured to store light illumination pattern data. Furthermore, the device 10 further includes a power module 30 having a power amplifier 32 configured to charge pump the power module 30.

In operation of one embodiment of the signaling device 10, a user turns on the signaling device 10, wherein the power amplifier 32 begins to charge pump the power module 30. The user then displaces the device 10 in a side to side horizontal motion as illustrated in FIG. 1; thereby generating acceleration data through the accelerometer 14. Then the control module 16 processes the multi-axis acceleration data and then generates light illumination data according to the processed acceleration data and provides it to the elongated light group 12, thereby displaying an image about the center of the displacement motion by the user according to the orientation of the device as observed by the processed accelerometer data. In addition, the device 10 is configured to acknowledge the orientation of the device 10 relative to the ground, wherein the device 10 is able to recognize when being displaced in a horizontal or vertical motion. As illustrated in FIG. 2, the device 10 recognizes the vertical motion and thereby generates light illumination data associated with the vertical displacement. Furthermore, the device 10 is configured to adjust the image displayed about the center of the swings to the rate at which the swings are made by the user. A user may swing the device twice as fast as another user, the device is configured to read this output and adjust the image accordingly. The device 10 is also configured to adjust the device, if the user is swinging the device twice as slow as another user, and configure the image accordingly.

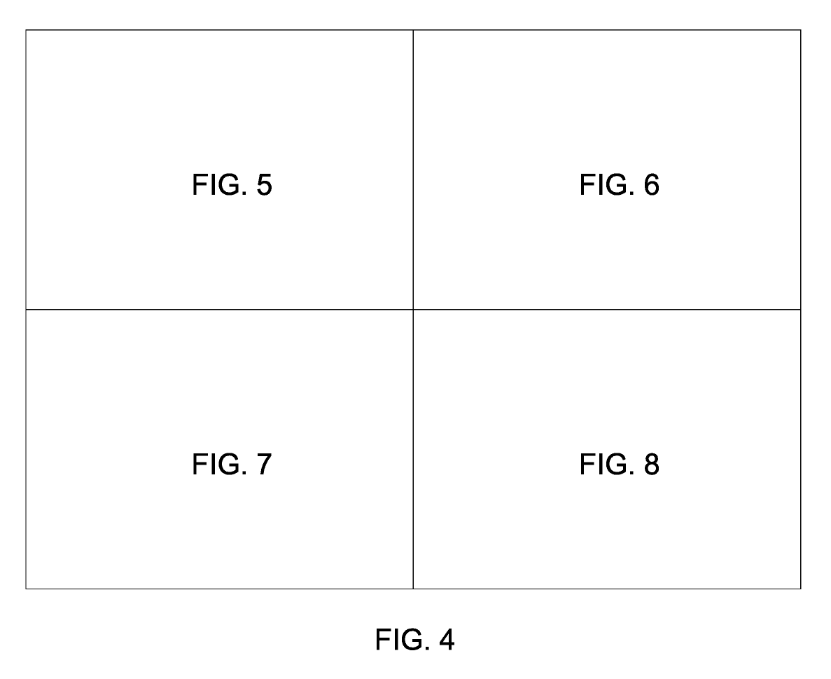

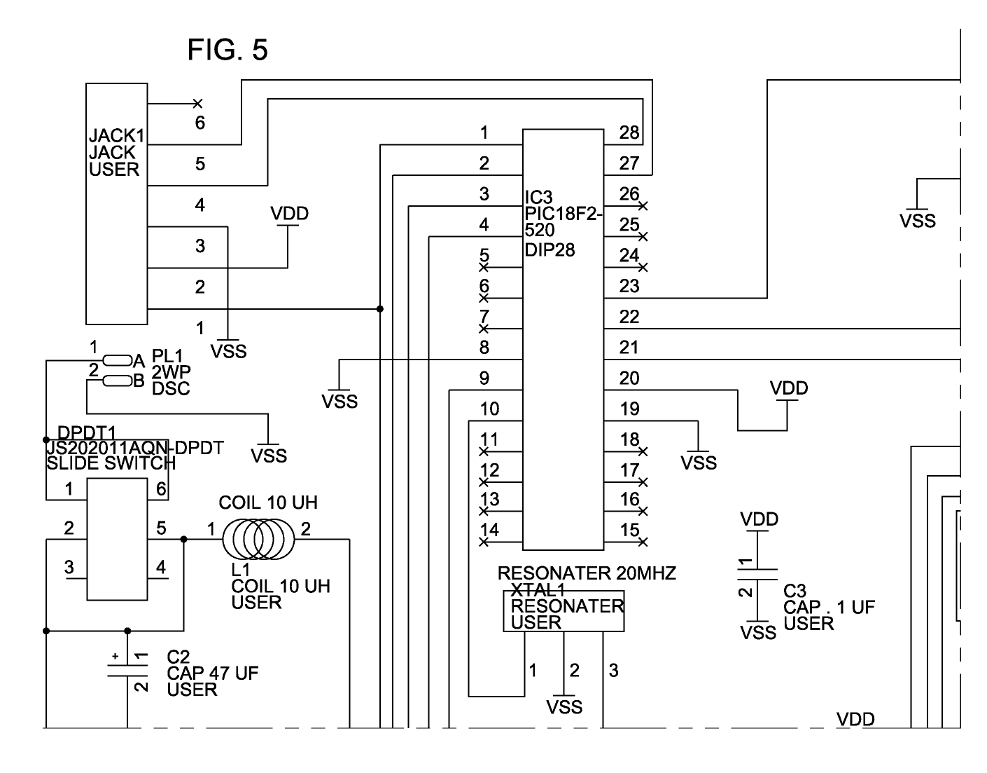

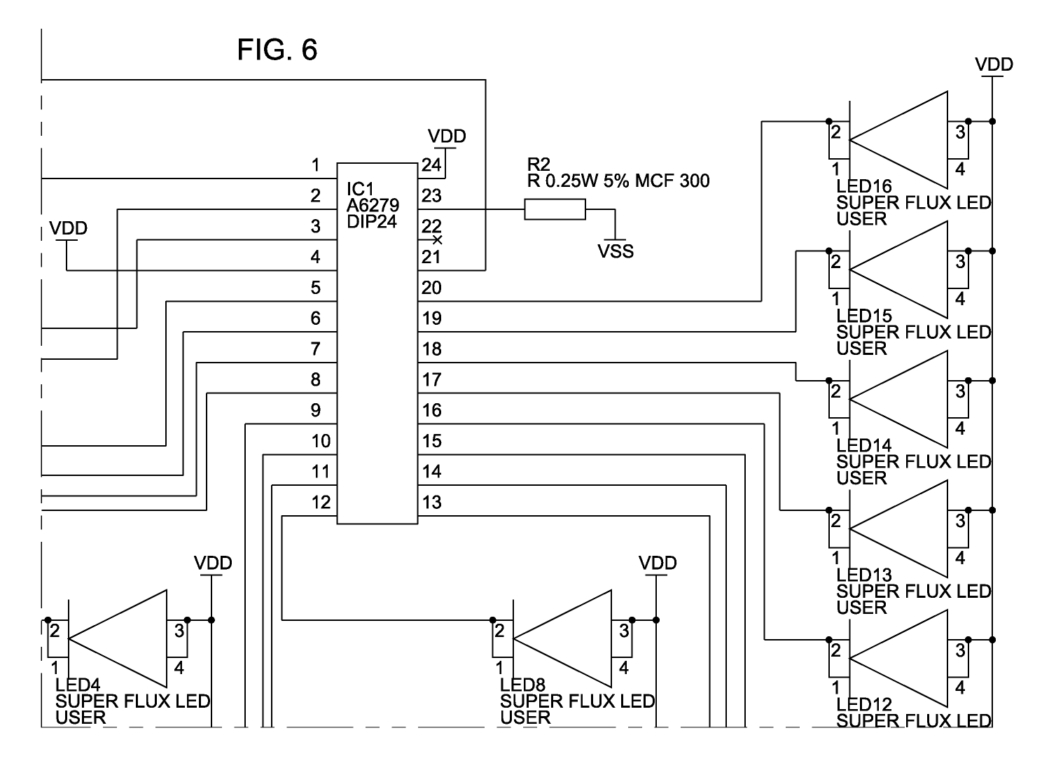

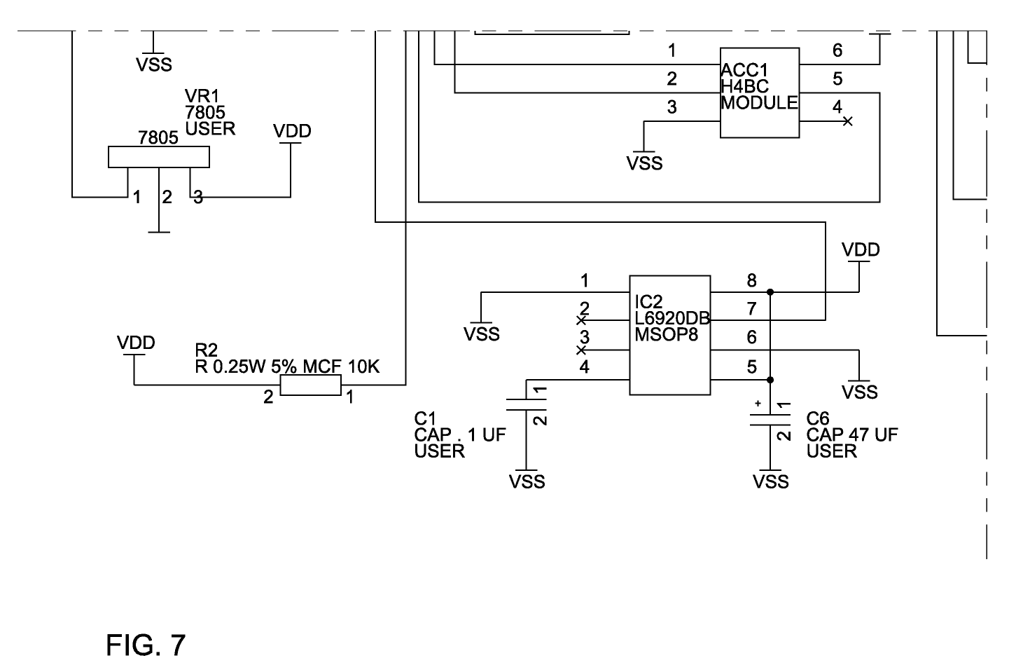

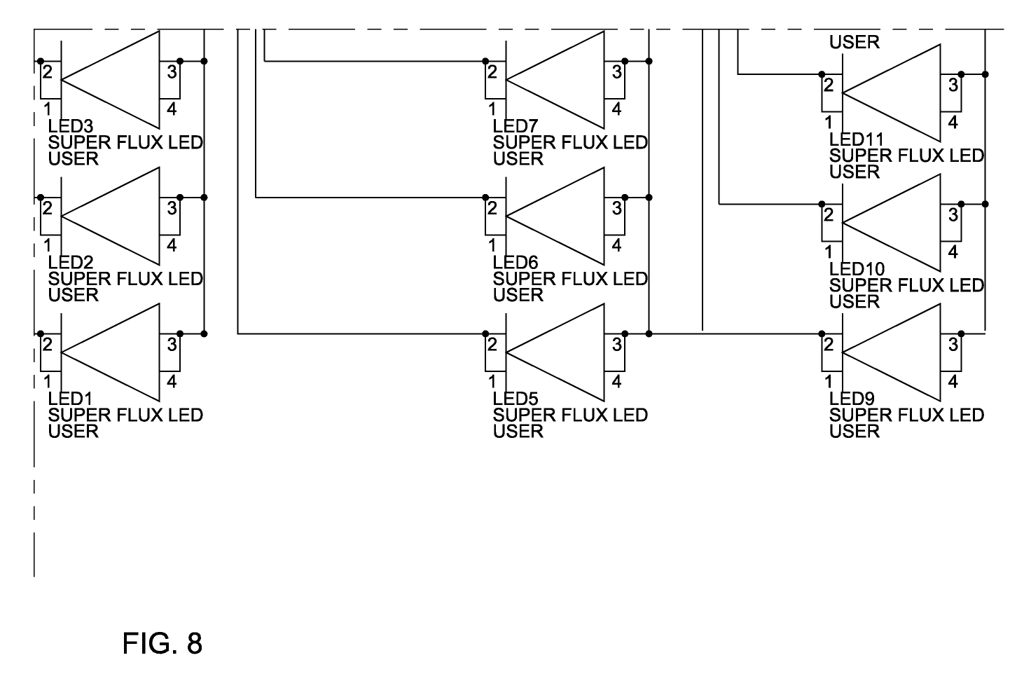

FIG. 4 illustrates how a circuit diagram of a signaling device 10, according to one embodiment of the invention, is illustrated in FIGS. 5 -8. FIGS. 5-8 illustrate a circuit diagram of a signaling device 10, according to one embodiment, wherein the device 10 includes a multi-axis accelerometer 14. As illustrated in FIG. 7, the multi-axis accelerometer 14 ACC1 H48C module, is configured to provide multi-axis device acceleration data. FIG. 5 illustrates the multi-axis accelerometer 14 in communication with a control module 16, IC3 PIC18F2520 DIP28, configured to process multi-axis acceleration data and configured to generate light illumination data. Also illustrated in FIG. 7, the control module 16 is coupled to a power module 30 having a power amplifier 32, IC2 L6920DB MSOP8, configured to charge pump the power module 30. The control module 16 is also in communication with an elongated light group 12, Super Flux LEDs, wherein the light group 12 is configured to selectably project light from portions of the group. One skilled in the art would also appreciate that the LEDs may vary with the advancement in technology; one non-limiting example may be new surface mounted LEDs. Also illustrated in FIGS. 6 and 8, the elongated light group 12 further comprises a plurality of point lights 34, wherein the lights display visual information.

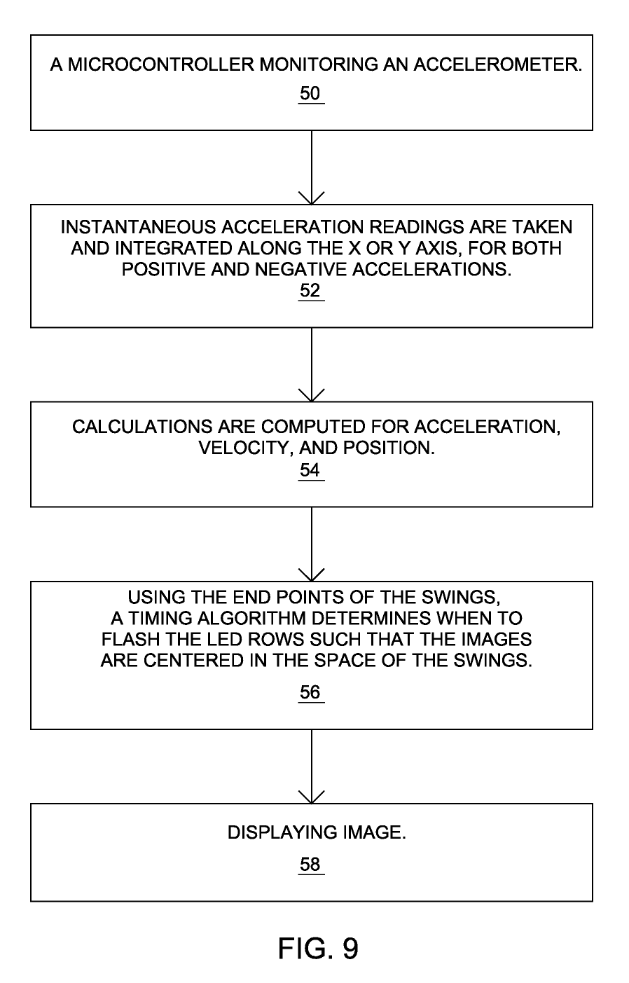

FIG. 9 illustrates a method of calculating multi-axis accelerometer data, wherein a microcontroller, or control module, monitors a multi-axis accelerometer at a fixed rate 50; such as, 500 times per second for example, and that the number of readings per displacement is a function of how fast the user is displacing the device. The control module is continuously reading the accelerometer at a fixed rate. When the instantaneous acceleration readings suddenly change from negative to positive, that is, the “start” of a displacement cycle. The next time the acceleration values change from negative to positive, which is the end of one complete displacement cycle. There may be 267, or 312, or any number of readings in this period of time, depending on how fast the user displaces the device. That number is used as part of the timing calculations to help center the images disposed about the displacement of the device. Non-limiting examples may be that the accelerometer may be configured to record and process readings every 100, 200, 300, 500 readings per swing. Instantaneous acceleration readings are taken and integrated along the device's X axis for both positive and negative accelerations 52. The integrated accelerations are effectively proportional to velocity of the device along its X axis. Therefore, the velocities are integrated to effectively determine position, wherein the average position is zero as the user swings the unit from side to side; and the average velocity is zero as the user swings the unit from side to side. The sum of the positive accelerations therefore equals the sum of the negative accelerations 54. The way it really works is that the accelerometer is always read at a fixed rate,

The human arm accelerates the device 10 in a non-predictable pattern, where the point of maximum acceleration is not typically at the end points of the swings. However, when half of the summed positive accelerations are reached, the zero velocity point is reached, and this is a good indication of the end point of the swing. This algorithm, is therefore, a very noticeable improvement over any inertial mechanism used to determine end points of the swings. Using the end points of the swing, a timing algorithm determines when to flash the light group, such that, the images are centered in the space of the swings. When swinging from left to right, the light group is displayed in one order to form the image, when swinging from right to left, the order of the light group displayed is reversed, resulting in the same image formed due to persistent vision 56.

When the device 10 is swung horizontally along the device's X axis, the Y axis acceleration readings determine the direction of gravity, and hence the orientation of the device. If held upside down, a different set of messages is automatically displayed. When the device is turned 90 degrees and swung vertically, the device's Y axis readings are nearly zero in both directions due to the missing gravity component, and one of the X axis acceleration integrated sums is greater then the other due to gravity. This allows automatic determination of two more orientations. For each of these four orientations a unique set of images and messages is automatically displayed.

A light group having a plurality of light points allows efficient display of each pixel row of the image 58. Each pixel location in the perceived image is a function of the space where each light point is positioned as it is turned on. Brightness of each pixel is a function of the length of space, or the length of the dash of light as each light point is turned on for a given length of motion. Color mixing is a function of the length of each dash of light as the various color LEDs are turned on during motion. Note that without motion, this display will not display an image. The information content is space-modulated, rather than time-modulated, and in one embodiment no time-based pulse-width-modulation is used. A momentary contact push button allows the user to select from many different sets of messages. This light point temporarily flashes a message set number to the user as the button is pressed. During normal swinging display of the device this button is not in use. Each message is comprised of sequential sets of images for each of the four orientations.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the light group includes a single row of lights, one skilled in the art would appreciate that the lights may vary in size, shape, color, length, width, configuration, design, and orientation and still perform its intended function. One non-limiting example may be there may be a plurality of rows, in addition to a plurality of colored LEDs and still perform its intended function.

Additionally, although the figures illustrate a signaling device including a protective housing having a handle, one skilled in the art would appreciate that the protective housing may vary in size, shape, length, width, configuration, design, orientation and still perform its intended function.

It is also envisioned, one skilled in the art would appreciate, that there may be a plurality of signaling devices in communication therein, and configured to display a plurality of images and still perform its intended function.

It is expected that there could be numerous variations of the design of this invention. An example is that the control module may be a central database in wireless communication with the signaling device configured to broadcast a plurality of images and still perform its intended function.

Finally, it is envisioned that the components of the device may be constructed of a variety of materials, metal, metal alloys, plastic, plastic composite, rubber, rubber composite, textiles, and still perform its intended function.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of, or to consist essentially of, one or more of the features, functions, structures, or methods described herein.

What is claimed is:

1. A signaling device, configured to selectably display visual information, comprising:
a) an elongated light group configured to selectably project light from portions of the group;
b) a multi-axis accelerometer configured to provide multi-axis device acceleration data;
c) a control module, in communication with the multi-axis accelerometer and the elongated light group and configured to process multi-axis acceleration data and configured to generate light illumination data and provide it to the elongated light group; and
d) a trigger module, in communication with the control module configured to toggle the light illumination data.

2. The device of claim 1, wherein the device further comprises a protective housing having a handle.

3. The device of claim 2, wherein the control module further comprises a program module configured to provide selectably programmable light illumination data.

4. The device of claim 3, wherein the device further comprises a selectably removable storage module, in communication with the control module, configured to store light illumination pattern data.

5. The device of claim 4, wherein the control module further comprises a wireless communication module.

6. The device of claim 5, wherein the device further comprises a power module having a power amplifier configured to charge pump the power module.

7. The device of claim 6, wherein the elongated light group further comprises a plurality of point lights.

8. The device of claim 7, wherein the device further comprises a communication module in communication with the control module configured to provide remote communication with the device.

9. A signaling system, configured to selectably display visual information, comprising:
a) an elongated light group configured to selectably project light from portions of the group;
b) a multi-axis accelerometer configured to provide multi-axis device acceleration data;
c) a control module, in communication with the multi-axis accelerometer and the elongated light group and configured to process multi-axis acceleration data and configured to generate light illumination data and provide it to the elongated light group; and
d) a trigger module, in communication with the control module configured to toggle the light illumination data.

10. The system of claim 9, wherein the device further comprises a protective housing having a handle.

11. The device of claim 9, wherein the control module further comprises a program module configured to provide selectably programmable light illumination data.

12. The device of claim 9, wherein the device further comprises a selectably removable storage module, in communication with the control module, configured to store light illumination pattern data.

13. The device of claim 9, wherein the control module further comprises a wireless communication module.

14. The device of claim 9, wherein the device further comprises a power module having a power amplifier configured to charge pump the power module.

15. The device of claim 9, wherein the elongated light group further comprises a plurality of point lights.

16. The device of claim 9, wherein the device further comprises a communication module in communication with the control module configured to provide remote communication with the device.

17. A signaling device, configured to selectably display visual information, comprising:
a) an elongated light group configured to selectably project light from portions of the group; wherein the elongated light group further comprises a plurality of point lights;
b) a multi-axis accelerometer configured to provide multi-axis device acceleration data;
c) a control module, in communication with the multi-axis accelerometer and the elongated light group and configured to process multi-axis acceleration data and configured to generate light illumination data and provide it to the elongated light group; wherein the control module further comprises a program module configured to provide selectably programmable light illumination data; wherein the control module further comprises a wireless communication module;
d) a trigger module, in communication with the control module configured to toggle the light illumination data;
e) a protective housing having a handle;
f) a selectably removable storage module, in communication with the control module, configured to store light illumination pattern data;
g) a power module having a power amplifier configured to charge pump the power module; and
h) a communication module in communication with the control module configured to provide remote communication with the device.

18. A method of displaying visual information using a signaling device, comprising:
a) using a microcontroller to monitor an accelerometer;
b) instantaneous acceleration readings are taken and integrated along the X or Y axis, for both positive and negative accelerations;
c) calculations are computed for acceleration, velocity and position;
d) using the end points of the swings and a timing algorithm to determine when to flash the LED rows such that images are centered in the space of the swings; and
e) displaying an image.
